(19) United States
(12) Patent Application Publication
(10) Pub. No.: US 2006/0280651 A1
(43) Pub. Date: Dec. 14, 2006

(54) INDUSTRIAL BIOSYNTHESIZER SYSTEM AND METHOD

(76) Inventors: Louis Bellafiore, Wilmette, IL (US); John Walker, Evanston, IL (US); James Sanderson, Chicago, IL (US)

Correspondence Address: PATENT GROUP;ATTN: J. KENNETH JOUNG, DLA PIPER RUDNICK GRAY CARY US LLP, 203 N. LASALLE ST., SUITE 1900, CHICAGO, IL, 60601, US

(21) Appl. No.: 11/379,114

(22) Filed: Apr. 18, 2006

Related U.S. Application Data
(60) Provisional application No. 60/672,476, filed on Apr. 18, 2005.

(51) Int. Cl. C40B 30/04; C40B 50/02; G01N 21/00

(52) U.S. Cl. 422/62

(57) ABSTRACT

A synthesizer system for use as either a freestanding or facility integrated device and a method of use. The system includes an inlet manifold of diaphragm valves that receives at least two liquid feeds. The streams flow either to a blending module or directly to a delivery module. From there they are delivered to a reactor for the sequential creation of desired compounds. For flow through solid phase synthesis added capability for feed recirculation and effluent detection with feedback control is included.

### CLAIM OF PRIORITY

This application claims priority from U.S. Provisional Patent Application Ser. No. 60/672,476, filed Apr. 18, 2005.

### BACKGROUND OF THE INVENTION

The present invention relates generally to automated synthesis systems that enable the laboratory, pilot or commercial ssale synthesis of biological or biologically active compounds, such as peptides and oligonucleotides.

The combination of building-block components (e.g. amino acids, amidites) to create compounds with specific properties is widely used to create pharmaceutical, biopharmaceutical, veterinary, agricultural, nutraceutical, cosmetic and other fine chemical products. In general these compounds are of high value and may be used at low dosage levels to produce desired effects.

Automated synthesis systems provide many advantages over performing these frequently lengthy and detailed processes manually. Examples of prior art automated synthesis systems are presented in U.S. Pat. No. 5,641,459 to Holmberg and U.S. Pat. No. 5,807,525 to Allen et al. By using an automated system, each synthesis step can be more precisely monitored, controlled and reproduced. This automation reduces costs associated with reagent and building-block materials by more efficiently utilizing them and results in higher yields of desired product at lower cost. Operational costs are also reduced including labor and facility costs. In addition, validation and quality control costs to confirm synthetic product makeup and disposal costs of non-compliant product is reduced. Increased ability to meet time critical delivery whether for clinical trials or commercial product can eliminate the costs of such delays which can be in the range of millions of dollars per week. The benefit of the improved process reproduciblity is seen both from a regulatory (FDA) perspective where cGMP guidelines mandate a state of control be maintained throughout manufacturing processes, as well as from a manufacturing science view which predicts the lowest cost of manufacture and highest quality products results from processes which exhibit the least run to run variability. A further benefit of such reproducible processes is that multiple smaller scale runs can be made to generate material on an “as needed” basis, rather than making large scale single batches at high risk in the case of failure and the resulting stockpiling of material, which decomposes over time.

A high degree of accuracy and reproducibility for the additions of each building block and reagent is vital. Quality management directives call for increased synthesis step accuracy for industrial processes that are used to create commercial products. Indeed, Six Sigma quality control principles demonstrate that lower variability in an industrial process results in a greater percentage of higher quality products being produced by that process.

It is well known, however, that even with available automated systems these types of syntheses generate crude product material that have highly variable amounts of product and impurities, mandating extensive post-process purifications and reduced product recovery. The effectiveness of the developed purification strategy is further compromised with the variable product feeds that result from poorly controlled syntheses.

FIG. 1 illustrates a prior art approach to synthesis that has been widely used from bench scale to large scale production. Feedstocks, supplied from containers or tanks, are each connected to inlets 10 and delivered through a dedicated flow path, typically via pumps 12, to a reaction vessel 14. Each flow path usually includes a diaphragm valve (not shown in FIG. 1). The diaphragm valves are positioned in front of each pump if pumps are present. Such an arrangement is used for solution phase synthesis (additions create a “soup” of building blocks and reagents), stirred solid phase synthesis (a solid particle with the starting building blocks attached becomes part of a “soup” of building blocks and reagents) or flow-through solid phase synthesis (the particles are held in place in a tube with screen/frit supports and the reactants are passed through).

### SUMMARY OF THE INVENTION

The present invention is directed to accurate laboratory, pilot and commercial scale synthesizer systems and a method of use. The system incorporates inlet valve modules to permit the isolated delivery of building block components (e.g. amino acids, amidites, etc.) and reagents into the system. Additionally the capability of performing solvent flushing of the inlet valves and lines between additions to prevent carryover is provided. The reagents and building block components can be delivered simply from pressurized containers or the system can include a single main pump dedicated to delivering reagents and building block components (e.g. amino acids, amidites, etc.) to the reaction vessel module. A second pump can be incorporated and dedicated to the delivery of reagents to the reaction vessel module. A second pump can be incorporated and dedicated to the delivery of reagents to the reaction vessel module. A flow control module is used to control the flow rate and totalize the volume delivery of building block components and reagents to the reaction vessel module. A Process Analytical Technology (PAT) detection module detects the composition of the building block components prior to addition to the reaction vessel and communicates the analysis it to a controller. The controller will alarm the operator to out-of-specification conditions based upon the detected composition so that only a desired composition is delivered to the reaction vessel module. A blending module further permits in-line convergence and blending of the two incoming liquid streams (i.e. building block components and reagents), as they are delivered to the reaction vessel. In the case of solid phase synthesis, the reaction vessel contains a synthesis bed support (typically a starting building block attached to a polymeric resin substrate) upon which the biomolecules (e.g. oligonucleotide or peptide ) are built. In the case of flow through solid phase synthesis, a second PAT detection module analyzes the composition of the liquid stream exiting the reaction vessel and communicates it to a controller. In this case a re-circulation module may also be present to permit liquids to be re-circulated through the reaction vessel which can provide more effective syntheses for certain processes.

The following detailed description of embodiments of the invention, taken in conjunction with the appended claims and accompanying drawings, provide a more complete understanding of the nature and scope of the invention.

### BRIEF DESCRIPTION OF THE DRAWINGS

FIG. 1 is a flow diagram illustrating a prior art approach to synthesis of biologically active compounds such as peptides and oligonucleotides;

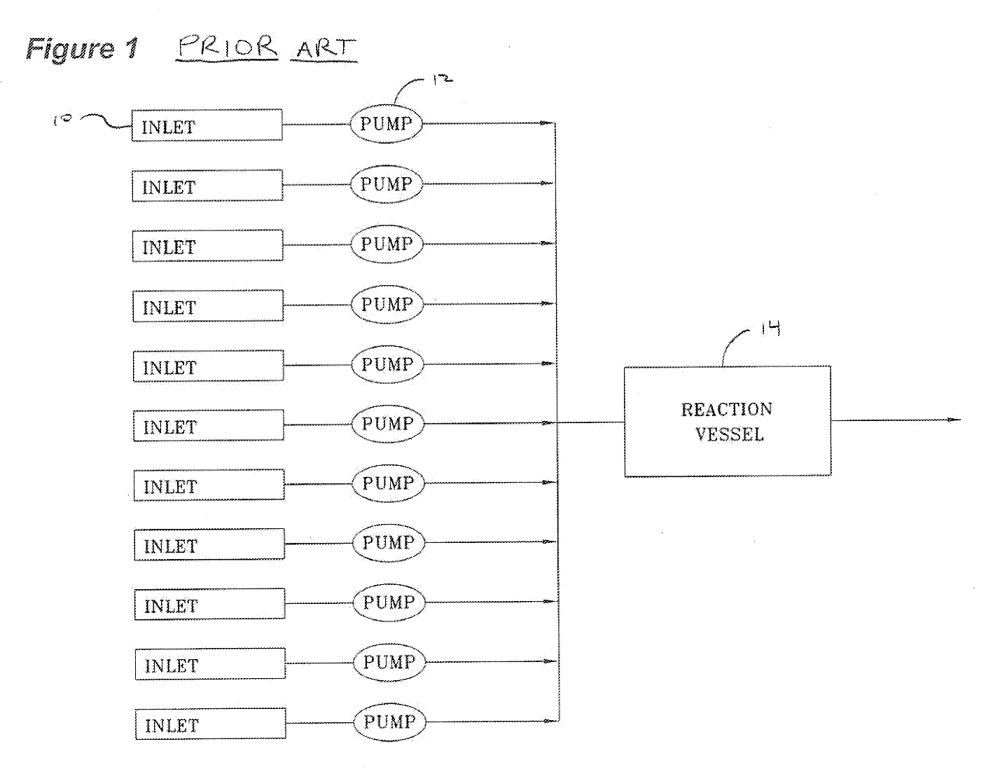

FIG. 2 is a flow diagram illustrating an embodiment of the synthesizer system of the present invention;

FIG. 3 is a detailed flow diagram of one of the inlet modules of the system of FIG. 2;

FIG. 4 is a perspective view of an embodiment of the synthesizer system of the present invention mounted on a cart;

FIG. 5 is an enlarged perspective view of one of the zero static inlet valve clusters of FIGS. 2 and 3.

### DESCRIPTION OF THE PREFERRED EMBODIMENTS

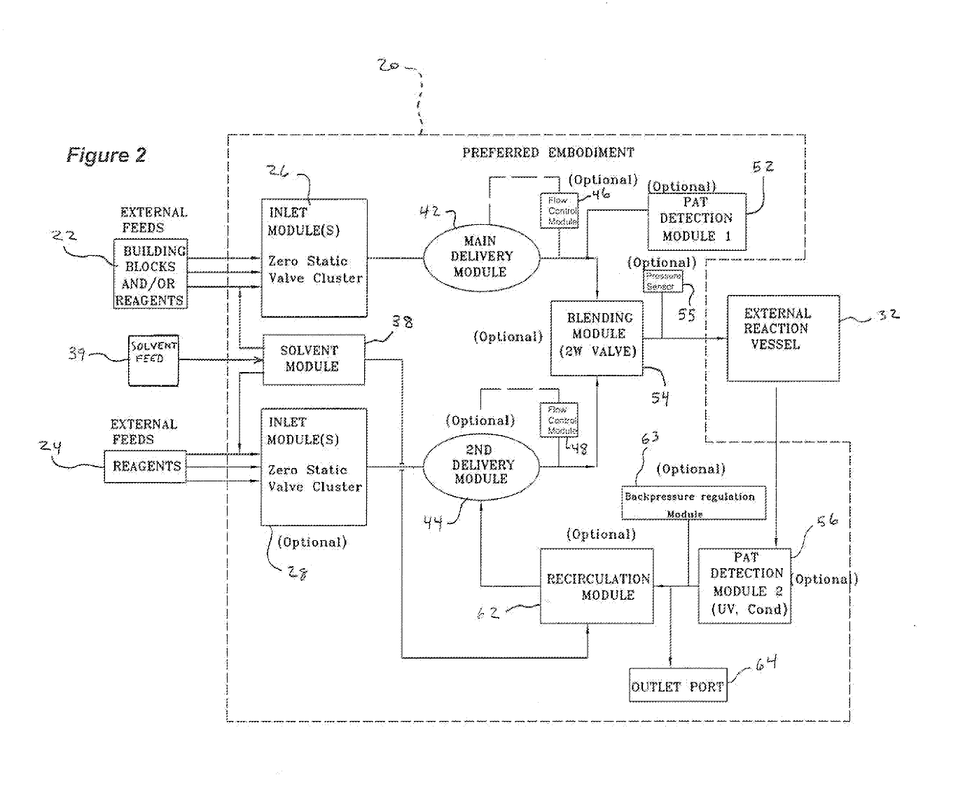

With reference to FIG. 2, an embodiment of the biosynthesis system of the present invention is indicated at 20. User-supplied building block components in solution (e.g. amino acids or amidites) 22 and liquid reagents 24 are connected to the appropriate inlet modules 26 and 28 to permit their sequential additions in order to synthesize the target biomolecule (e.g. peptide or oligonucleotide) in the external reaction vessel 32. The synthesis is achieved by the system 20 by delivering the building block components and reagents to the reaction vessel at controlled flow rates and/or volumes in a specific sequence. One or more inlet modules may be included on one biosynthesis system; the exact number of inlets being dependent on the total number of building blocks and reagents required for the synthesis of the biomolecule (e.g. peptide or oligonucleotide) of interest.

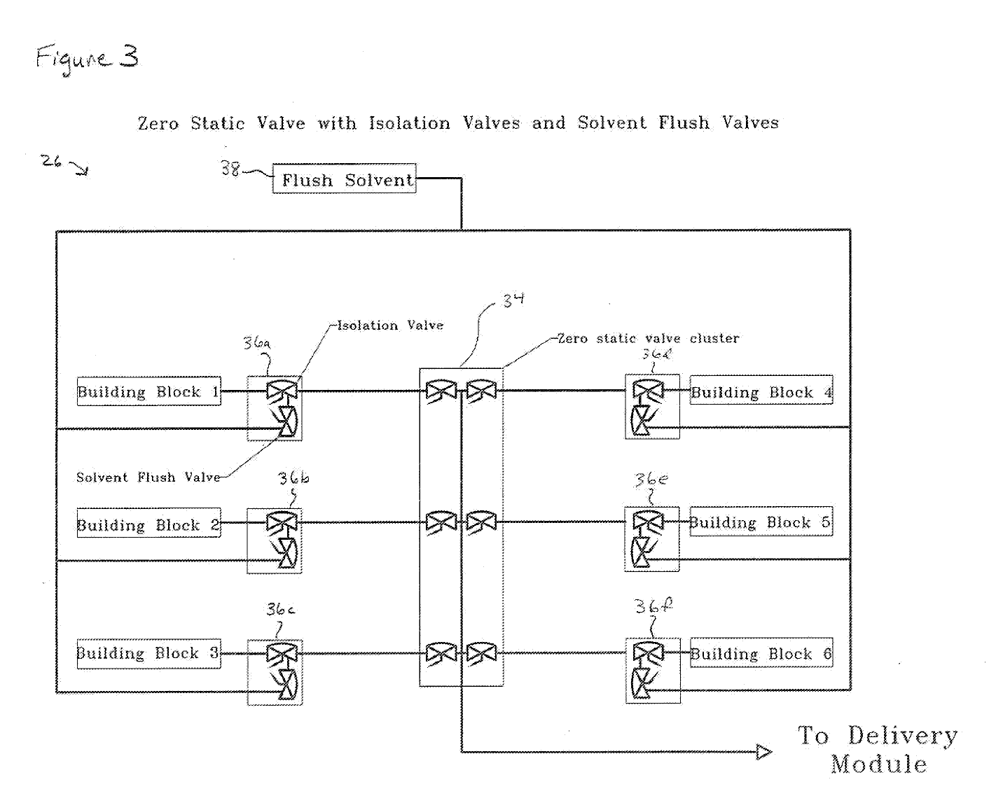

In accordance with the present invention, the inlet modules each consist of multiple valves arranged appropriately to reduce the possibility of building block or reagent carryover when changing from one inlet feed to another. More specifically, in accordance with the present invention, each inlet module 26 or 28 features one or more diaphragm valve manifolds, each consisting of a multi-port cluster diaphragm valve configuration, or in the preferred embodiment, a multi-port zero static diaphragm valve configuration, indicated at 34 in FIG. 3 for inlet module 26, in order to maximize the reduction in building block/reagent carryover. It should be noted that while the manifold 34 of FIG. 3 show six valves, manifolds featuring any number of valves more than one are contemplated by the present invention.

Each inlet module is connected to the system controller. The appropriate inlet valve is opened by the system controller according to which of the connected liquid building block components or reagents is required for a given step in the synthesis sequence.

As illustrated in FIG. 3, the inlet module, indicated in general at 26, may also include additional diaphragm valves 36a-36f upstream of the manifold assembly 34 to permit solvent flushing of the valve manifold and lines to make them free of the added component after the addition of the building block or reagent is complete. Flush solvent is provided by supply 38 (illustrated in FIGS. 2 and 3) which receives solvent from solvent feed 39 (FIG. 2).

Additional diaphragm isolation valves 36a-36f upstream of the manifold assembly may also be included to further isolate the building blocks/reagents from cross-contamination with another feed.

Once the appropriate inlet valve has been opened by the controller, a delivery module, illustrated at 42 and 44 in FIG. 2, that may include an appropriate pump, is activated to permit delivery of the feed liquid to the external reaction vessel 32. A main pump can be dedicated to selectively delivering all building block components as well as reagents (e.g. amino acids, amidites, etc.) to the reaction vessel module. Alternatively, a second pump can be dedicated to reagent additions. In the preferred embodiment illustrated in FIG. 2, both a main pump (in main delivery module 42) and a second pump (in 2^{nd} delivery module 44) are of a sanitary design to reduce carryover such as provided with a sanitary Lewa diaphragm design pump. Additionally, the use of the triplex of 5-head pumps provide a reduction of delivery pulsations to the synthesis bed to minimize possible flow or pressure related disruption of the bed during synthesis steps.

Flow-control modules 46 and 48 are optionally located downstream of the main pump and second pump modules. The flow-control modules incorporate mass flow meters in the preferred embodiment to accurately measure and control the addition of building block components and reagents to the reaction vessel, via control of the main and 2^{nd} delivery modules 42 and 44, in respect to flow rate and totalized volume of each addition.

The flow meters are interfaced with the system controller. The outputted signal from the flow meter(s) of the flow-control module, which is typically an analog signal, provides the controller with a Process Valve (PV). A Set Point (SP) will have been set in the controller by the user via a user interface (such as a PC). Based on the discrepancy between the measured PV and the user-defined SP, the controller continually adjusts the signal that is sent to the pump motors of the main and 2^{nd} delivery modules 42 and 44.

Additional details regarding a suitable controller system may be obtained from commonly owned U.S. patent application Ser. No. 10/688,391, filed Oct. 17, 2003, the contents of which are hereby incorporated by reference.

As indicated in FIG. 2, a PAT detection module 52 may be optionally positioned downstream of one of the delivery modules (in the illustrated example, main delivery module 42) and flow control modules 46 and 48. A sensor within the PAT detection module 52 communicates the composition of the incoming liquid stream to the controller. More specifically, the outputted signal from the sensor of the PAT detection module, which is typically analog, provides the controller with a Process Value (PV). A Set Point (SP) will have been set in the controller by the user via a user interface. Based on the discrepancy between the measured PV and the user-defined SP, the controller's program will compare the PV to the SP, and if a deviation outside of the user-defined tolerance is measured, then an alarm is activated and the liquid is not delivered to the reaction vessel in order to prevent the synthesis of an incorrect biomolecule.

The PAT detection module 52 may utilize different sensor types. For example, an ionic (e.g. conductivity or pH for a salt solution) and spectral (e.g. near-infrared or ultraviolet-VIS for organic solutions) measurement of the liquid, as appropriate, may be made by an in-line sensor. The PAT detection module 53 may alternatively use a range of sensor types including NIR, conductivity, temperature, pH, etc. Basically any sensor that can detect properties of the critical (and/or variable) feed and outputs a measurable signal may be used. Examples of other suitable sensors include fixed or variable wavelength near infrared or ultraviolet sensors (such as those manufactured by Wedgewood, Foss, Custom Sensors, Optek and Knauer), and conductivity sensors (such as those manufactured by TBI Bailey and Wedgewood).

A blending module 53 permits in-line convergence and blending of the two liquid streams coming from the main and 2^{nd} delivery modules, specifically a building block component and a reagent, while they are being delivered to the reaction vessel 32. For example, a building block component may need to be activated by a reagent in order for the building block to chemically link to the starting component or partially completed molecule in the reaction vessel. The blending module permits in-line blending of the two liquids within the biosynthesis system to preclude the need for pre-mixing the liquids offline. The blending module may include two-way valving and a length of tubing or static mixer to enhance mixing. The optional two-way valving allows streams from just main delivery module 42 or 2^{nd} delivery module 42 to be blended or stream from both delivery modules to be blended.

The liquid or liquids that pass through the blending module 54 are directed into the external reaction vessel 32. In solid phase synthesis, the reaction vessel contains the resin upon which the biomolecule (e.g. oligonucleotide or peptide) is built. It can use a flow-through design or a stirred-bed reactor design in which stirrer(s) mix the suspended resin and additions.

An optional pressure sensor 55 is positioned between the blending module 54 and the reaction vessel 32 and regulates the delivery of liquid to the reaction vessel so that a uniform pressure may be maintained in reaction vessel 32.

A second PAT detection module 56 may optionally be incorporated downstream of the reaction vessel for biosynthesis systems that incorporate flow-through reaction vessels. This module includes the same types of sensors used by the first PAT detection module 52 such as ionic (e.g. conductivity) and/or spectral (e.g. near-infrared or ultraviolet-VIS) detectors which can detect the composition of the liquid stream passing through the reaction vessel and communicate it to a controller. A control strategy can be used to advance to subsequent steps based on the measured make-up of the effluent from the reaction vessel which can indicate the completeness of reaction due to consumption of reagent or building block and the resulting change in sensor output signal. Such a strategy can include the implementation and control of re-circulation steps via optional recirculation module 62 which can be continued until full utilization of these high value added reactants is complete.

The system optionally features a backpressure regulation module 63 which maintains a uniform pressure in the reaction vessel 32.

Recirculation module 62 may feature its own pump or may just feature valving and tubing to use the pumps of the main or 2^{nd} delivery modules or a single system pump. As illustrated in FIG. 2, recirculation module 62 may also selectively receive solvent from solvent module 38 and circulate it through the system and out outlet port 64 so that the recirculation system may be directly flushed.

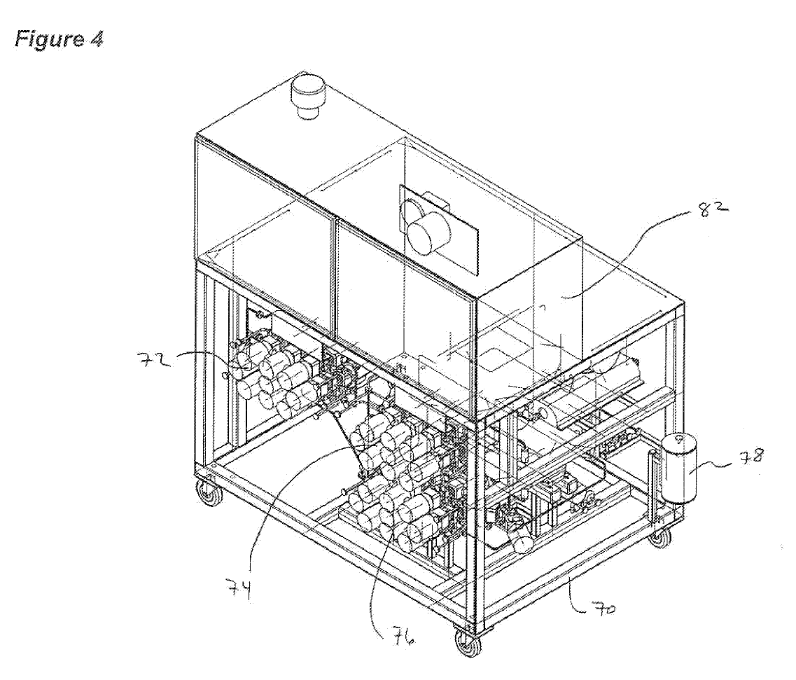

FIG. 4 shows an embodiment of the system of the present invention mounted on a cart 70. The system of FIG. 4 features three inlet modules 72, 74 and 76. Each inlet module features a manifold having nine diaphragm valves facing the front side of the cart that are visible in FIG. 4. In addition, each manifold features horizontally-opposed isolation and flush valves facing the back side of the cart that receive solvent, as described with respect to FIG. 3 of the application. The external reaction vessel 78 is optionally attached to the cart 70. A cabinet 82 is positioned on top of the cart and houses the system controllers and other electronics.

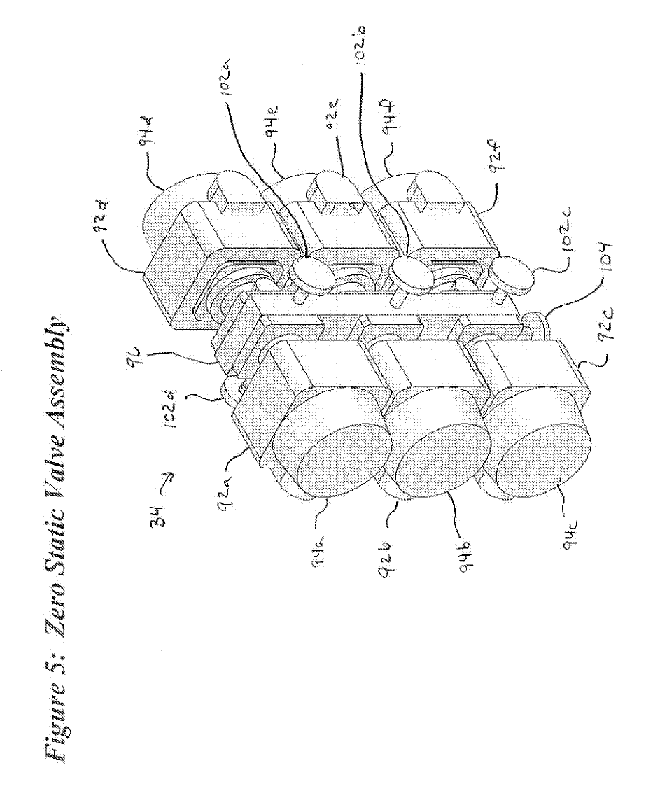

An enlarged view of a manifold constructed in accordance with the present invention is indicated in general at 34 in FIG. 5 (and corresponds to manifold 34 of FIG. 3). The six zero static diaphragm valves 92a-92f of the manifold each is optionally equipped with a valve status indicator with feedback 94a-94f (such as a proximity switch). The manifold body is indicated at 96 and four of the six valve inlet ports are illustrated at 102a-102d (valve inlet ports 102e and 102f are horizontally opposed from ports 102b and 102c but hidden from view in FIG. 5). The valve outlet port is illustrated at 104. While one outlet is illustrated, the manifold may have more than one outlet.

The embodiments of the system of the present invention described above may be used for solution phase synthesis (additions create a “soup” of building blocks and reagents), stirred solid phase synthesis (a solid particle with the starting building block attached becomes part of a “soup” of building blocks and reagents) or flow-through solid phase synthesis (the particles are held in place in a tube with screen/frit supports and the reactants are passed through).

While the preferred embodiments of the invention have been shown and described, it will be apparent to those skilled in the art that changes and modifications may be made therein without departing from the spirit of the invention, the scope of which is defined by the appended claims.

What is claimed is:

1. An automated compound synthesis system comprising:
a) an inlet module featuring a manifold having an outlet and a plurality of diaphragm valves, each of said diaphragm valves having an inlet adapted to communicate with an external feed of a building block or reagent; and
b) a delivery module in communication with the outlet of the manifold of the inlet module and receiving a feed stream therefrom, said delivery module adapted to communicate with a reaction vessel to deliver the feed stream to the reaction vessel.

2. The synthesis system of claim 1 wherein the diaphragm valves are multi-port cluster diaphragm valves.

3. The synthesis system of claim 1 wherein the diaphragm valves are multi-port zero static diaphragm valves.

4. The synthesis system of claim 1 further comprising a blending module in circuit between the delivery module and the reaction vessel.

5. The synthesis system of claim 1 further comprising a flow control module in circuit between the delivery module and the reaction vessel.

6. The synthesis system of claim 1 further comprising a PAT detection module in circuit between the delivery module and the reaction vessel.

7. The synthesis system of claim 4 wherein the blending module includes a valve or valves.

8. The synthesis system of claim 1 further comprising a cart provided with rollers upon which the system is mounted so that the system may be rolled across a surface.

9. A method for providing synthesis capability to a laboratory, pilot or commercial scale system including the steps of:
a) connecting at least two liquid feeds to a synthesizer and passing them through diaphragm valves arranged in a manifold; and
b) delivering the liquid feeds from the manifold to a reaction vessel.

10. The method of claim 9 further comprising the step of controlling the delivery of the liquid feeds to the reaction vessel by passing them through a flow control module.

11. The method of claim 9 further comprising the step of blending the feed streams with a blending module so that a blended liquid stream of feeds is produced prior the delivery to a reaction vessel.

12. The method of claim 9 further comprising the steps of detecting a composition of the feed liquid stream via a detection module and generating a corresponding signal and receiving the signal with the controller and controlling the inlet valve and/or delivery module with the controller based upon the received signal.

13. The method of claim 9 wherein the reaction vessel is a flow-through reactor.

14. The method of claim 13 further comprising the steps of
a) re-circulating of the reagents and/or reactants through the reactor;
b) receiving the effluent from the reaction vessel displaced by incoming feeds or otherwise;
c) using a post-reactor detection module to determine the completeness of reaction based on the detected signal for the reagent or reactant used in a step;
d) using a controller to determine whether to continue re-circulation, adjust the rate of re-circulation or stop the re-circulation; and
e) using the controller to determine whether to begin the next step or pause the system.

15. The method of claim 9 wherein the synthesizer inlet valve(s) are multi-port cluster diaphragm valves.

16. The method of claim 9 wherein the synthesizer inlet valve(s) are of a zero static design to reduce carryover and/or mixing of feed streams.

17. The method of claim 9 wherein the synthesizer inlet valve(s) are of a zero static design connected into a low dead volume valve assembly to provide the highest level of reduced carryover and/or mixing of feed streams.
